(19) United States
(12) Patent Application Publication
(10) Pub. No.: US 2018/0091263 A1
(43) Pub. Date: Mar. 29, 2018

(54) WIRELESS DEVICE AND METHOD THEREIN FOR PERFORMING A RETRANSMISSION OF DATA IN A DEVICE-TO-DEVICE, D2D, COMMUNICATION

(71) Applicant: Telefonaktiebolaget LM Ericsson (publ), Stockholm (SE)

(72) Inventors: Shaohua LI, Beijing (CN); Qianxi LU, Beijing (CN); Xinghua SONG, Beijing (CN); Stefano SORRENTINO, Solna (SE)

(21) Appl. No.: 15/564,058

(22) PCT Filed: Apr. 8, 2015
(86) PCT No.: PCT/CN2015/076085

§ 371 Date: Oct. 3, 2017

(51) Int. Cl. H04L 1/18; H04W 72/04

(52) U.S. Cl. CPC H04L 1/1816; H04L 1/1896; H04W 92/18; H04L 1/1854; H04L 1/1848; H04W 72/0406

(57) ABSTRACT

Embodiments herein relate to a method performed by a first wireless device for performing a transmission of data in a Device-to-Device, D2D, communication to a second wireless device. The transmission of the data is associated with a Hybrid Automatic Repeat reQuest, HARQ, process. The first wireless device first determines that an Acknowledgement or Non-Acknowledgement, ACK/NACK, message of the HARQ process has not been received from the second wireless device for the data during a determined period of time after the transmission of the data. Then, the first wireless device performs retransmissions of the data to the second wireless device until either an ACK message of the HARQ process is received from the second wireless device for the data or until a determined number of retransmissions of the data has been performed. Embodiments of the first wireless device are also described.

### TECHNICAL FIELD

Embodiments herein relate to performing retransmissions of data in a wireless device. In particular, embodiments herein relate to a first wireless device and a method therein for performing a retransmission of data in a Device-to-Device, D2D, communication to a second wireless device.

### BACKGROUND

In a typical wireless, cellular or radio communications network, wireless devices, also known as mobile stations, terminals, and/or User Equipment, UEs, communicate via a Radio-Access Network, RAN, with one or more core networks. The RAN covers a geographical area which is divided into cells, with each cell being served by a base station, e.g. a radio base station, RBS, or network node, which in some networks may also be called, for example, a “NodeB”, “eNodeB” or “eNB”. A cell is a geographical area where radio coverage is provided by the radio base station at a base station site or an antenna site in case the antenna and the radio base station are not collocated. One radio base station may serve one or more cells.

A Universal Mobile Telecommunications System, UMTS, is a third generation mobile communication system, which evolved from the second generation, 2G, Global System for Mobile Communications, GSM. The UMTS terrestrial radio-access network, UTRAN, is essentially a RAN using wideband code-division multiple access, WCDMA, and/or High-Speed Packet Access, HSPA, to communicate with user equipment. In a forum known as the Third Generation Partnership Project, 3GPP, telecommunications suppliers propose and agree upon standards for third generation networks and UTRAN specifically, and investigate enhanced data rate and radio capacity. In some versions of the RAN, as e.g. in UMTS, several base stations may be connected, e.g., by landlines or microwave, to a controller node, such as a radio network controller, RNC, or a base station controller, BSC, which supervises and coordinates various activities of the plural base stations connected thereto. The RNCs are typically connected to one or more core networks.

Specifications for the Evolved Packet System, EPS, have been completed within the 3^{rd} Generation Partnership Project, 3GPP, and this work continues in the coming 3GPP releases. The EPS comprises the Evolved Universal Terrestrial Radio-Access Network, E-UTRAN, also known as the Long-Term Evolution, LTE, radio access, and the Evolved Packet Core, EPC, also known as System Architecture Evolution, SAE, core network. E-UTRAN/LTE is a variant of a 3GPP radio-access technology wherein the radio base station nodes are directly connected to the EPC core network rather than to RNCs. In general, in E-UTRAN/LTE the functions of a RNC are distributed between the radio base station nodes, e.g. eNodeBs in LTE, and the core network. As such, the Radio-Access Network, RAN, of an EPS has an essentially flat architecture comprising radio base station nodes without reporting to RNCs.

In 3GPP Release 12, Device-to-Device, D2D, communication or Proximity Service, ProSe, capability has been proposed for LTE as an underlay to cellular or radio communications networks. This is proposed as a means to take advantage of the close proximity of communicating wireless devices and at the same time to allow these wireless devices to operate in a controlled interference environment. In this case, close proximity may typically refer to less than a few tens of meters, but sometimes even up to a few hundred meters.

This D2D or ProSe communication may share the same spectrum as the cellular or radio communications network, for example, by reserving some of the cellular uplink resources for D2D communication purposes. That is, locating D2D communication on cellular uplink, UL, resources in a way such that Time-Division Duplex, TDD, is the duplex transmission scheme of the D2D communication. The D2D communication may also be established and performed by the wireless devices only, which is also commonly referred to as an ad-hoc mode D2D communication, or be assisted by the network, also referred to as a network-assisted D2D communication. In the latter, a network may, for example, assist a D2D connection by establishing security of the D2D link and/or partly or fully controlling the setup of the D2D connection, such as, e.g. wireless device/peer discovery and resource allocation. Further, a network may also assist the D2D communication by controlling the interference environment.

One well known component of the Physical and Medium Access Control, PHY/MAC, layer in a wireless device is the Hybrid Automatic Repeat reQuest, HARQ, process mechanism.

To employ a HARQ process mechanism in a wireless device means that each transmission of data is associated with a HARQ process. In this case, the receiver of such transmitted data is configured to provide feedback in the form of an Acknowledgement or Non-Acknowledgement, ACK/NACK, message for the transmitted data associated with the HARQ process. For conventional HARQ transmissions, the timing of the ACK/NACK messages is fixed. This means that for each HARQ transmission, the corresponding ACK/NACK message is available according to a predetermined timing requirement.

However, when implementing such a HARQ process mechanism for D2D transmissions, there may be timing uncertainties for the feedback of ACK/NACK messages.

One reason is that the channel used to provide the feedback may be allocated based on a contention-based scheme. For a contention-based scheme, the feedback timing and the availability of the feedback channel is uncertain. Hence, a conventional HARQ process mechanism the D2D communication may result in that, for some HARQ transmissions, the feedback of the ACK/NACK message may not be possible or delayed, and hence not available at the transmitter. Another reason is that the resource configuration of a D2D communication may employ a D2D transmission resource pool and a D2D reception resource pool, and thus may be irregular. This means that a D2D transmission would take place in the D2D transmission resource pool, and the ACK/NACK reception of that D2D transmission would take place in the D2D reception resource pool. Since the D2D transmission resource pool often is independent of D2D reception resource pool and the subframes in the different pools are irregular, the HARQ transmission may not get its ACK/NACK feedback message when expected. A further reason may be that, when a receiver has data to send back to the transmitter, the ACK/NACK feedback message of the HARQ transmission may be multiplexed with the data. This means that, when the time resource pattern of the subframes are randomly determined, the timing of the ACK/NACK feedback message of the HARQ transmission will also be random.

In these types of cases, i.e. when the availability of the feedback channel is uncertain as described above, and the ACK/NACK feedback message is not available, the transmitter may assume that the data transmission was not successful and perform retransmissions of the data. Optionally, in some cases, the transmitter may assume that the receiver is not able to receive the data at one transmission layer, which may trigger a retransmission at another higher order transmission layer. Furthermore, in case of employing a timing interval for receiving ACK/NACK feedback messages of HARQ processes at the transmitter due to e.g. timing uncertainties, all HARQ processes within the timing interval may not be able to be terminated. In order to handle this, both the transmitter and the receiver may need to reserve a significant amount of buffer storage to store the data for which the transmission was not completed.

Hence, the feedback of ACK/NACK messages according to the conventional HARQ process mechanism may not work well for D2D communication, and may cause excessive retransmissions of data or cause excessive data of the incomplete transmission to be buffered in the wireless devices.

### SUMMARY

It is an object of embodiments herein to improve retransmissions of data in a D2D communication.

According to a first aspect of embodiments herein, the object is achieved by a method performed by a first wireless device for performing a transmission of data in a D2D communication to a second wireless device. The transmission of the data is associated with an HARQ process. The first wireless device determines that an Acknowledgement or Non-Acknowledgement, ACK/NACK, message of the HARQ process has not been received from the second wireless device for the data during a determined period of time after the transmission of the data. The first wireless device also performs retransmissions of the data to the second wireless device until either an ACK message of the HARQ process is received from the second wireless device for the data or until a determined number of retransmissions of the data has been performed.

According to a second aspect of embodiments herein, the object is achieved by a first wireless device for performing a transmission of data in a D2D communication to a second wireless device. The transmission of the data is associated with an HARQ, process. The first wireless device comprises a processor configured to determine that an ACK/NACK message of the HARQ process has not been received from the second wireless device for the data during a determined period of time after the transmission of the data. The processor is also further configured to perform retransmissions of the data to the second wireless device until either an ACK message of the HARQ process is received from the second wireless device for the data or until a determined number of retransmissions of the data has been performed.

According to a third aspect of embodiments herein, the object is achieved by a computer program, comprising instructions which, when executed on at least one processor, cause the at least one processor to carry out the method described above. According to a fourth aspect of embodiments herein, the object is achieved by a carrier containing the computer program described above, wherein the carrier is one of an electronic signal, optical signal, radio signal, or computer readable storage medium.

By performing retransmissions of data in a D2D communication until an ACK message is received or until a certain number of retransmissions has been performed for the data, the first wireless device is able to handle different timing irregularities of the ACK/NACK messages without causing an excessive amount of retransmissions or excessive buffering of data. Hence, the retransmission of data in the D2D communication is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic block diagram illustrating embodiments of a first wireless device in a wireless communications network,

FIG. 2 is a flowchart depicting embodiments of a method in a first wireless device,

FIG. 3 is another flowchart depicting embodiments of a method in a first wireless device,

FIG. 4 is a schematic block diagram depicting embodiments of a first wireless device.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

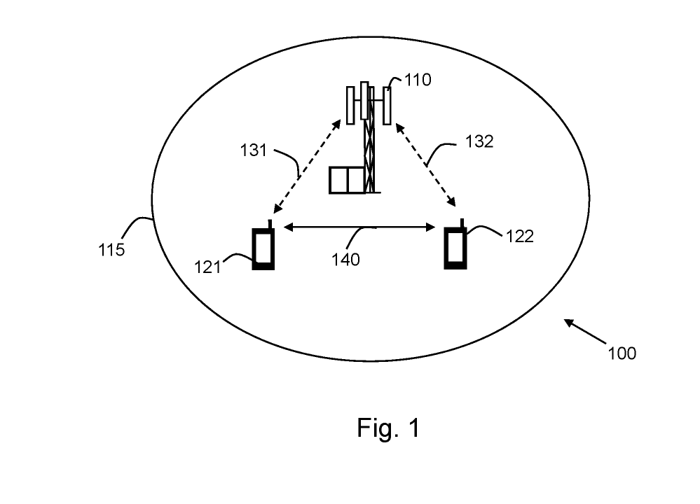

FIG. 1 shows an example of a wireless communications network 100 in which embodiments herein may be implemented. Although illustrated in FIG. 1 as an LTE network, the wireless communications network 100 may be any wireless or radio communication system, such as, LTE-Advanced, Wideband Code-Division Multiple Access (WCDMA), Global System for Mobile communications/Enhanced Data rate for GSM Evolution (GSM/EDGE), Worldwide Interoperability for Microwave Access (WiMax), Ultra Mobile Broadband (UMB) or GSM network, or other cellular network or system.

The wireless communications network 100 comprises a network node 110. The network node 110 may e.g. be an eNB, eNodeB, or a Home Node B, a Home eNode B, femto Base Station (BS), pico BS or any other network unit capable to serve a wireless device in the wireless communications network 100. The network node 110 may also be e.g. a radio base station, a base station controller, a network controller, a relay node, a repeater, an access point, a radio access point, a wireless access point, a Ultra-Dense Network/Software-Defined Network (UDN/SDN) radio access node, a Remote Radio Unit (RRU) or a Remote Radio Head (RRH). Furthermore, the network node 110 may comprise multiple antennas for wireless radio communication with wireless devices located within their coverage range; that is, the network node 110 may use one or more of its respective antennas to provide radio coverage within its cell 115.

In the example of FIG. 1, a first wireless device 121 and a second wireless device 122 is located within the cell 115. The first and second wireless device 121, 122 may be configured to communicate within the wireless communications system 100 via the network node 110 over a radio link 131, 132 when present in the cell 115 served by the network node 110. The first and second wireless device 121, 122 may e.g. be any kind of wireless device with D2D capability such as a mobile phone, a cellular phone, a Personal Digital Assistant (PDA), a smart phone, a tablet, a sensor or actuator with wireless communication capabilities, a sensor or actuator connected to or equipped with a wireless device, a Machine Device (MD), a Machine-Type-Communication (MTC) device, a Machine-to-Machine (M2M) communication device, a Customer-Premises Equipment (CPE), a Laptop-Mounted Equipment (LME), a Laptop-Embedded Equipment (LEE), etc.

The first and second wireless device 121, 122 is further capable of communicate with each other directly using wireless D2D communication over a D2D link 140. Thus, the first and second wireless device 121, 122 may be referred as a D2D pair of wireless devices, i.e. one pair of wireless devices using D2D communication. The D2D communication between the first and second wireless device 121, 122 may be so-called network-assisted D2D communication wherein the network node 110 supports and controls the D2D communication between the first and second wireless device 121, 122. Alternatively, the D2D communication between the first and second wireless device 121, 122 may be an ad-hoc mode D2D communication. That is, the D2D link 140 between the first and second wireless device 121, 122 has been established and/or is controlled and maintained by one or both of the first and second wireless device 121, 122 only.

The wireless communications network 100 described above is most commonly arranged to operate within a licensed frequency spectrum, i.e. regulated and dedicate frequency bands in which a centralized network controls the wireless or radio communication according to a certain predetermined standard. However, recent developments has opened up to expand the wireless communications network 100 to also operate in parts of the so-called unlicensed spectrum, i.e. unlicensed frequency bands which are shared, decentralized and not licensed to a particular type of scheduled wireless or radio communication. The spectrum may herein interchangeably be referred to as channel, radio channel, radio frequency resource, carrier frequency, carrier, frequency layer, etc. Examples of wireless technologies that today utilize the unlicensed spectrum may include Wi-Fi, Ultra Wideband, spread spectrum, software-defined radio, cognitive radio, and mesh networks. In the unlicensed spectrum, wireless devices of different wireless technologies compete with each other about having access to and transmitting on the transmission resources within the spectrum. Hence, the channel sharing of these transmission resources may be referred to as contention-based.

In some embodiments, the first and second wireless device 121, 122 are capable of, and may be configured to, transmit and receive D2D data transmissions to or from each other using contention-based transmission resources of the same frequency in the wireless communications network 100.

Furthermore, although embodiments below are described for the sake of clarity with reference to the scenario of FIG. 1, this scenario should not be construed as limiting to the embodiments herein, but merely as an example made for illustrative purposes.

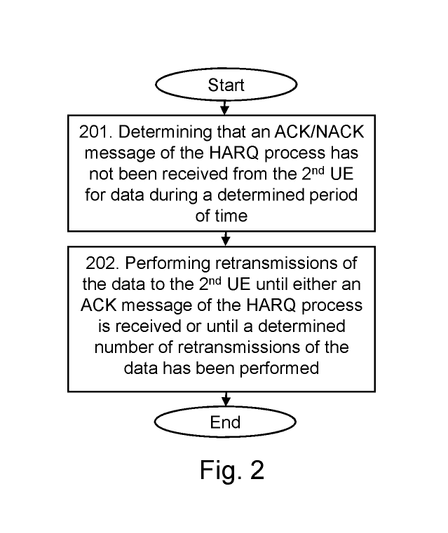

Example of embodiments of a method performed by a first wireless device 121 for performing a retransmission of data in a Device-to-Device, D2D, communication to a second wireless device 122, will now be described with reference to the flowchart depicted in FIG. 2. The transmission of the data is associated with a Hybrid Automatic Repeat reQuest, HARQ, process. FIG. 2 illustrates an example of actions or operations which may be taken by the first wireless device 121. The method may comprise the following actions.

Action 201

The first wireless device 121 determines that an Acknowledgement or Non-Acknowledgement, ACK/NACK, message of the HARQ process has not been received from the second wireless device 122 for the data during a determined period of time after the transmission of the data. For example, the first wireless device 121 may configure a timer for each HARQ process in order to check the availability of the ACK/NACK message. If an ACK/NACK message for a data transmission of a HARQ process is not detected or received before the timer for the HARQ process has expired, the ACK/NACK message for this data transmission of the HARQ process may be considered as unavailable.

Action 202

After determining that an ACK/NACK message of the HARQ process has not been received as described in Action 201, the first wireless device 121 perform retransmissions of the data to the second wireless device 122 until either an ACK message of the HARQ process is received from the second wireless device 122 for the data or a determined number of retransmissions of the data has been performed. By performing retransmissions of the data in a D2D communication until an ACK message is received for the data, or until a certain number of retransmissions have been performed, the first wireless device 121 is able to handle timing irregularities of the ACK/NACK messages without causing an excessive amount of retransmissions or excessive buffering of data. Such excessive amount of retransmissions or excessive buffering of data may otherwise be the result of implementing a conventional HARQ process mechanism for the D2D communication as previously described above. Furthermore, this also improves the HARQ transmission efficiency by performing HARQ feedback based on when transmissions resources are available, which may be useful when contention-based transmission resources are employed in the wireless communications network 100.

In some embodiments, when receiving a NACK message of the HARQ process from the second wireless device 122 for the data, the first wireless device 121 may perform a retransmission of the data based on the NACK message. This means that two types of retransmissions is defined. A first type of retransmission of the data is performed an ACK/NACK message of the HARQ process is considered not available, and a second type of retransmission of the data is performed when an ACK/NACK message of the HARQ process is available. In the latter case, the retransmission of data is based on whether or not the content of the ACK/NACK message of the HARQ process is ACK or a NACK. That is, if the ACK/NACK message is an NACK message, then a retransmission of the data is performed. On the contrary, if the ACK/NACK message is an ACK message, then a retransmission of the data is not needed and thus not performed.

In some embodiments, the determined number of retransmissions may be the total number of retransmissions performed as a result of not receiving an ACK/NACK message of the HARQ process from the second wireless device 122 for the data during a determined time period after the transmission or a retransmission of the data. In this case, only retransmissions performed as a result of not receiving an ACK/NACK message is considered.

Optionally, according to some embodiments, the determined number of retransmissions is the total number of retransmissions performed as a result of not receiving an ACK/NACK message of the HARQ process from the second wireless device 122 for the data during a determined time period after the transmission or a retransmission of the data, and retransmissions performed as a result of receiving an NACK message of the HARQ process from the second wireless device 122 for the data. In this case, retransmissions performed as a result of receiving a NACK message is also considered.

It should be noted that the timing possibilities for providing HARQ feedback for the data transmission of the D2D communication by the second wireless device 122, i.e. the available transmission resources for transmitting the ACK/NACK message of a HARQ process for the received data transmission by the second wireless device 122, may or may not be known by the first wireless device 121. For example, even though the first wireless device 121 does not know when to expect a HARQ feedback from the second wireless device 122 at moment of the data transmission, there are a set of potential transmission resources that may be used by the second wireless device 122 for returning the HARQ feedback to the first wireless device 121. Thus, according to the embodiments above, the first wireless device 121 may determine its retransmission behaviour based on whether the HARQ feedback for the data transmission is successfully received within a determined period of time.

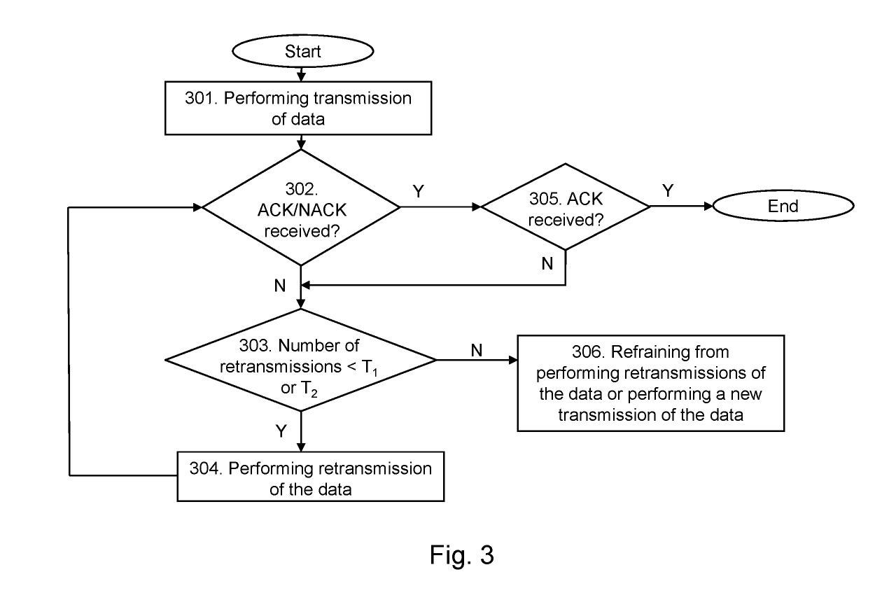

More detailed examples of the embodiments of the method described above with reference to the flowchart depicted in FIG. 2, will now be described with reference to the flowchart depicted in FIG. 3.

Action 301

Initially, the first wireless device 121 performs a data transmission in the D2D communication that is associated with a HARQ process.

Action 302

The first wireless device 121 then determines whether or not an ACK/NACK message of the HARQ process has been received. If an ACK or a NACK message of the HARQ process has been received within a determined period of time, the first wireless device 121 may proceed to Action 305. If neither an ACK nor a NACK message of the HARQ process has been received within the determined period of time, the first wireless device 121 may proceed to Action 303.

In some embodiments, a timer is configured to decide the availability of the ACK/NACK message of the HARQ process. In this case, upon performing the data transmission, the timer is started. Then, upon receiving an ACK/NACK message of the HARQ process for the data transmission, the timer is stopped and reset. When the timer expires without any ACK/NACK message of the HARQ process for the data transmission has been received, the first wireless device 121 considers the ACK/NACK message of the HARQ process for the data transmission as not available.

Action 303

Here, the first wireless device 121 determines whether or not the number of retransmission of the data is below a determined threshold, T₁ or T₂. Here, for example, the determined threshold, T₁, may only consider retransmissions performed as a result of not receiving an ACK/NACK message, while the determined threshold, T₂, may also consider retransmissions performed as a result of receiving a NACK message.

If the number of retransmission of the data is below the determined threshold, the first wireless device 121 may proceed to Action 304. If the number of retransmission of the data is above or equal to the determined threshold, the first wireless device 121 may proceed to Action 306.

Action 304

In response to determining that the number of retransmission of the data is below the determined threshold in Action 303, the first wireless device 121 performs a retransmission of the data.

Action 305

If an ACK message of the HARQ process has been received within a determined period of time, the first wireless device 121 may consider the data transmission successful, whereby no retransmissions of the data is considered necessary. Hence, the first wireless device 121 may, for example, proceed with a new transmission of further data in the D2D communication. If a NACK message of the HARQ process has been received within the determined period of time, the first wireless device 121 may proceed to Action 303.

Action 306

If the number of retransmission of the data is above or equal to the determined threshold in Action 303, the first wireless device 121 may refrain from performing any further retransmissions of the data in the D2D communication, or and perform a new transmission of the data in the D2D communication.

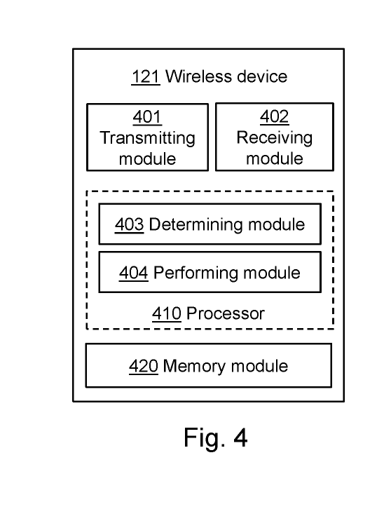

To perform the method actions for performing a retransmission of data in a Device-to-Device, D2D, communication to a second wireless device 122, the first wireless device 121 may comprise the following arrangement depicted in FIG. 4. The transmission of the data is associated with an Automatic Repeat reQuest, ARQ, process.

FIG. 4 shows a schematic block diagram of embodiments of the first wireless device 121. In some embodiments, the first wireless device 121 may comprise a receiving module 401, a transmitting module 402, and a processor 410. The receiving module 401 may also be referred to as a receiver or receiving unit, and the transmitting module 402 may also be referred to as transmitter or transmitting unit.

The processor 410 may also be referred to as processing module, processing unit or processing circuitry. The processor 410 is configured to, or a determining module 411 in the first wireless device 121 is configured to, determine that an Acknowledgement or Non-Acknowledgement, ACK/NACK, message of the ARQ process has not been received from the second wireless device 122 for the data during a determined period of time after the transmission of the data. The processor 410 is also configured to, or a performing module 412 in the first wireless device 121 is configured to, perform retransmissions of the data to the second wireless device 122 until either an ACK message of the HARQ process is received from the second wireless device 122 for the data or until a determined number of retransmissions of the data has been performed. The processor 410 also controls the receiver 801 and the transmitter 402. Optionally, the processor 410 may be said to comprise one or more of the receiver 401 and the transmitter 402, and/or perform the function thereof.

In some embodiments, the processor 410 may be further configured to, or the performing module 412 in the first wireless device 121 may be further configured to, perform a retransmission of the data based on the NACK message when receiving a NACK message of the ARQ process from the second wireless device 122 for the data. In some embodiments, the determined number of retransmissions is the total number of retransmissions performed as a result of not receiving an ACK/NACK message of the ARQ process from the second wireless device 122 for the data during a determined time period after the transmission or a retransmission of the data. In some embodiments, the determined number of retransmissions is the total number of retransmissions performed as a result of not receiving an ACK/NACK message of the ARQ process from the second wireless device 122 for the data during a determined time period after the transmission or a retransmission of the data, and retransmissions performed as a result of receiving an NACK message of the ARQ process from the second wireless device 122 for the data.

The embodiments for performing a retransmission of data in a Device-to-Device, D2D, communication to a second wireless device 122 may be implemented through one or more processors, such as, e.g. the processor 410 in the first wireless device 121 depicted in FIG. 4, together with computer program code for performing the functions and actions of the embodiments herein. The program code mentioned above may also be provided as a computer program product, for instance in the form of a data carrier carrying computer program code or code means for performing the embodiments herein when being loaded into the processor 410 in the first wireless device 121. The computer program code may e.g. be provided as pure program code in the first wireless device 121 or on a server and downloaded to the first wireless device 121. The carrier may be one of an electronic signal, optical signal, radio signal, or computer-readable storage medium, such as, e.g. electronic memories like a RAM, a ROM, a Flash memory, a magnetic tape, a CD-ROM, a DVD, a Blueray disc, etc.

The first wireless device 121 may further comprise a memory 420, which may be referred to or comprise one or more memory modules or units. The memory 420 may be arranged to be used to store executable instructions and data to perform the methods described herein when being executed in or by the processor 410 of the first wireless device 121. Those skilled in the art will also appreciate that the processor 410 and the memory 420 described above may refer to a combination of analog and digital circuits, and/or one or more processors configured with software and/or firmware, e.g. stored in the memory 420, that when executed by the one or more processors, such as, the processor 410, cause the one or more processors to perform the method as described above. The processor 410 and the memory 420 may also be referred to as processing means. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

From the above it may be seen that some embodiments may comprise a computer program product, comprising instructions which, when executed on at least one processor, e.g. the processor 410, cause the at least one processor to carry out the method for performing a retransmission of data in a Device-to-Device, D2D, communication to a second wireless device 122. Also, some embodiments may further comprise a carrier containing said computer program product, wherein the carrier is one of an electronic signal, optical signal, radio signal, or computer-readable storage medium.

The terminology used in the detailed description of the particular embodiments illustrated in the accompanying drawings is not intended to be limiting of the described network node 110, first wireless device 121 and methods therein which instead should be construed in view of the enclosed claims.

As used herein, the term “and/or” comprises any and all combinations of one or more of the associated listed items.

Further, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation. The common abbreviation “etc.”, which derives from the Latin expression “et cetera” meaning “and other things” or “and so on” may have been used herein to indicate that further features, similar to the ones that have just been enumerated, exist.

As used herein, the singular forms “a”, “an” and “the” are intended to comprise also the plural forms as well, unless expressly stated otherwise. It will be further understood that the terms “includes,” “comprises,” “including” and/or “comprising,” when used in this specification, specify the presence of stated features, actions, integers, steps, operations, elements, and/or components, but do not preclude the presence or addition of one or more other features, actions, integers, steps, operations, elements, components, and/or groups thereof.

Unless otherwise defined, all terms comprising technical and scientific terms used herein have the same meaning as commonly understood by one of ordinary skill in the art to which the described embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The embodiments herein are not limited to the above described preferred embodiments. Various alternatives, modifications and equivalents may be used. Therefore, the above embodiments should not be construed as limiting.

### Abbreviations

D2D Device to device
CSI Channel state information
ProSe Proximity services
HARQ Hybrid Automatic Repeat Request
LTE Long term evolution
3GPP 3rd Generation Partnership Project
QoS Quality of service
RRM Radio resource management
RSRP Reference signal receive power
RSRQ Reference Signal Received Quality
ACK Acknowledgement
NACK Negative or Non-Acknowledgement
WAN Wireless access network
D2DSS D2D secondary synchronization channel
PD2DSCH Physical D2D share channel
UE User equipment
PUSCH Physical uplink share channel
CQI Channel quality indicator
PMI Precoding matrix indicator
RI Rank indicator
RS Reference signal
SINR Signal to interference and noise ratio

1. A method performed by a first wireless device for performing a retransmission of data in a Device-to-Device, D2D, communication to a second wireless device, the transmission of the data being associated with a Hybrid Automatic Repeat reQuest, HARQ, process, the method comprising:
determining that one of an Acknowledgement or a Non-Acknowledgement, ACK/NACK, message of the HARQ process has not been received from the second wireless device for the data during a determined period of time after the transmission of the data; and
performing retransmissions of the data to the second wireless device until the occurrence of either one of:
an ACK message of the HARQ process is received from the second wireless device for the data; and
a determined number of retransmissions of the data has been performed.

2. The method according to claim 1, further comprising performing, when receiving a NACK message of the HARQ process from the second wireless device for the data, a retransmission of the data based on the NACK message.

3. The method according to claim 1, wherein the determined number of retransmissions is the total number of retransmissions performed as a result of not receiving an ACK/NACK message of the HARQ process from the second wireless device for the data during a determined time period after the transmission or a retransmission of the data.

4. The method according to claim 1, wherein the determined number of retransmissions is the total number of retransmissions performed as a result of not receiving an ACK/NACK message of the HARQ process from the second wireless device for the data during a determined time period after the transmission or a retransmission of the data, and retransmissions performed as a result of receiving an NACK message of the HARQ process from the second wireless device for the data.

5. A first wireless device for performing a retransmission of data in a Device-to-Device, D2D, communication to a second wireless device, the transmission of the data being associated with a Hybrid Automatic Repeat reQuest, HARQ, process, the first wireless device comprising:
a processor configured to:
determine that an Acknowledgement or Non-Acknowledgement, ACK/NACK, message of the HARQ process has not been received from the second wireless device for the data during a determined period of time after the transmission of the data; and
perform retransmissions of the data to the second wireless device until the occurrence of either one of:
an ACK message of the HARQ process is received from the second wireless device for the data; and
a determined number of retransmissions of the data has been performed.

6. The first wireless device according to claim 5, wherein the processor is further configured to perform, when receiving a NACK message of the HARQ process from the second wireless device for the data, a retransmission of the data based on the NACK message.

7. The first wireless device according to claim 5, wherein the determined number of retransmissions is the total number of retransmissions performed as a result of not receiving an ACK/NACK message of the HARQ process from the second wireless device for the data during a determined time period after the transmission or a retransmission of the data.

8. The first wireless device according to claim 5, wherein the determined number of retransmissions is the total number of retransmissions performed as a result of not receiving an ACK/NACK message of the HARQ process from the second wireless device for the data during a determined time period after the transmission or a retransmission of the data, and retransmissions performed as a result of receiving an NACK message of the HARQ process from the second wireless device for the data.

9. The first wireless device according to claim 5, further comprising a memory wherein the memory contains instructions executable by the processor.

10. A computer storage medium storing instructions which, when executed on at least one processor of a first wireless device, cause the at least one processor to perform a method for retransmission of data in a Device-to-Device, D2D, communication to a second wireless device, the transmission of the data being associated with a Hybrid Automatic Repeat reQuest, HARQ, process, the method comprising:
determining that one of an Acknowledgement or a Non-Acknowledgement, ACK/NACK, message of the HARQ process has not been received from the second wireless device for the data during a determined period of time after the transmission of the data; and
performing retransmissions of the data to the second wireless device until the occurrence of either one of:
an ACK message of the HARQ process is received from the second wireless device for the data; and
a determined number of retransmissions of the data has been performed.

11. (canceled)

12. The method according to claim 2, wherein the determined number of retransmissions is the total number of retransmissions performed as a result of not receiving an ACK/NACK message of the HARQ process from the second wireless device for the data during a determined time period after the transmission or a retransmission of the data.

13. The method according to claim 2, wherein the determined number of retransmissions is the total number of retransmissions performed as a result of not receiving an ACK/NACK message of the HARQ process from the second wireless device for the data during a determined time period after the transmission or a retransmission of the data, and retransmissions performed as a result of receiving an NACK message of the HARQ process from the second wireless device for the data.

14. The first wireless device according to claim 6, wherein the determined number of retransmissions is the total number of retransmissions performed as a result of not receiving an ACK/NACK message of the HARQ process from the second wireless device for the data during a determined time period after the transmission or a retransmission of the data.

15. The first wireless device according to claim 6, wherein the determined number of retransmissions is the total number of retransmissions performed as a result of not receiving an ACK/NACK message of the HARQ process from the second wireless device for the data during a determined time period after the transmission or a retransmission of the data, and retransmissions performed as a result of receiving an NACK message of the HARQ process from the second wireless device for the data.

16. The first wireless device according to claim 6, further comprising a memory wherein the memory contains instructions executable by the processor.

17. The first wireless device according to claim 7, further comprising a memory wherein the memory contains instructions executable by the processor.

18. The first wireless device according to claim 8, further comprising a memory wherein the memory contains instructions executable by the processor.

19. The computer storage medium according to claim 10, wherein the instructions, when executed on the at least one processor of the first wireless device, further perform, when receiving a NACK message of the HARQ process from the second wireless device (122) for the data, a retransmission of the data based on the NACK message.

20. The computer storage medium according to claim 10, wherein the determined number of retransmissions is the total number of retransmissions performed as a result of not receiving an ACK/NACK message of the HARQ process from the second wireless device for the data during a determined time period after the transmission or a retransmission of the data.

21. The computer storage medium according to claim 10, wherein the determined number of retransmissions is the total number of retransmissions performed as a result of not receiving an ACK/NACK message of the HARQ process from the second wireless device for the data during a determined time period after the transmission or a retransmission of the data, and retransmissions performed as a result of receiving an NACK message of the HARQ process from the second wireless device for the data.
